(19) United States
(12) Patent Application Publication
(10) Pub. No.: US 2025/0342311 A1
(43) Pub. Date: Nov. 6, 2025

(54) SYSTEM AND METHOD FOR GENERATING CONTENT BASED ON USER INPUT

(71) Applicant: DistrictWon, Rocky River, OH (US)

(72) Inventors: Peter Fitzpatrick, Fairview Park, OH (US); Regan Fitzpatrick, Fairview Park, OH (US); Michael Duff, Matthews, NC (US); Samuel Arseneault, Smiths Creek, MI (US)

(21) Appl. No.: 19/198,095

(22) Filed: May 4, 2025

Related U.S. Application Data
(60) Provisional application No. 63/642,725, filed on May 4, 2024.

(51) Int. Cl. G06F 40/20; G06F 9/451; G06F 40/166

(52) U.S. Cl. CPC G06F 40/20; G06F 9/451; G06F 40/166

(57) ABSTRACT

System and method for generating custom content and reports about a subject based on user input received from a human user and potentially from one or more other sources related to the subject is disclosed. The system and method dynamically prompt one or more deep learning models using the user input to generate custom content, which is then incorporated into a draft report. The prompts may potentially incorporate an author persona characterizing a user, which may include an entity user, and in some embodiments the author persona may have been previously generated based on prior publications or editing. In some embodiments, individualized data may be obscured and confounding data may be included when prompting the one or more deep learning models. An editor may edit the draft report, including making refinements to the custom content, enabling the creation of tailored reports that reflect the user's intent and preferences.

### RELATED APPLICATIONS

This application claims the benefit under 35 U.S.C. 119 (e) of U.S. Provisional Application Ser. No. 63/642,725, filed May 4, 2024, entitled “SYSTEM AND METHOD FOR GENERATING REPORTS AND ARTICLES”, and 63/762,800, filed Feb. 25, 2025, entitled “SYSTEM AND METHOD FOR GENERATING CONTENT BASED ON USER INPUT”, the entire contents of each of which are incorporated herein by reference.

### BACKGROUND

There is a need for systems and methods that allow users and organizations to easily leverage deep learning models to generate content and reports (e.g., news stories, club and organizational reports and articles, etc.) based on user input in a manner that allows for editing and governance review.

In addition, the prevalence of models—the use of models in systems and services—is ever increasing. Likewise, the capabilities of models to make inferences based on data is also ever increasing. The amount of data generated by individuals based on their activities (transaction or activity data), or that is generated based on individuals' characteristics (e.g., biometric data) is also ever increasing. Such trends increase the likelihood that smaller amounts of data and seemingly more random data may be used successfully to identify individuals—that the pool of personally identifiable information (PII) and/or pool of data that is capable of being used to identify a person (collectively, identifying data) is increasing. Therefore, there is a need for systems and methods that protect an individual's identity from being inferred by models based on identifying data.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a schematic drawing illustrating portions of a system useful for generating reports using deep learning models based on user input, in accordance with one or more embodiments set forth herein.

FIG. 2A is a line drawing showing a device displaying a graphical user interface for receiving user input, in accordance with one or more non-limiting embodiments set forth herein.

FIG. 2B is a line drawing showing a device displaying more of the graphical user interface of FIG. 2A, in accordance with one or more non-limiting embodiments set forth herein.

FIG. 2C is a line drawing showing a device displaying a graphical user interface for editing a draft report, in accordance with one or more non-limiting embodiments set forth herein.

FIG. 2D is a line drawing showing a device displaying more of the graphical user interface of FIG. 2C, in accordance with one or more non-limiting embodiments set forth herein.

FIG. 3A is a schematic drawing illustrating portions of a system useful for generating reports using deep learning models based on user input, in accordance with one or more non-limiting embodiments set forth herein.

FIG. 3B is a line drawing illustrating an example form of a custom content prompt utilized in one or more embodiments of a system useful for generating reports using deep learning models based on user input, in accordance with one or more non-limiting embodiments set forth herein.

FIG. 3C is a line drawing illustrating an example form of an entity persona utilized in one or more embodiments of a system useful for generating reports using deep learning models based on user input, in accordance with one or more non-limiting embodiments set forth herein.

FIG. 3D is a schematic drawing illustrating portions of a system useful for generating reports using deep learning models based on user input, in accordance with one or more non-limiting embodiments set forth herein.

FIG. 4A is a flow chart illustrating an example method for generating reports using deep learning models based on user input, in accordance with one or more non-limiting embodiments set forth herein.

FIG. 4B is a first portion of a flow chart illustrating an example method for generating reports using deep learning models based on user input, in accordance with one or more non-limiting embodiments set forth herein.

FIG. 4C is the second portion of the flow chart of FIG. 4B.

FIG. 5 is a schematic drawing illustrating certain aspects of a system useful for protecting individual identities from being inferred by models, in accordance with one or more non-limiting embodiments set forth herein.

FIG. 6 is a flow chart illustrating an example method for generating reports about a person using deep learning models that protects the person's identity from being inferred by the deep learning models, in accordance with one or non-limiting more embodiments set forth herein

FIG. 7A is a component block diagram showing a high-level logical arrangement of certain components for an exemplary computer system which may be employed to practice one or more embodiments set forth herein, or portions thereof.

FIG. 7B is a component block diagram showing a more granular logical arrangement of certain components demonstrating an architecture for an exemplary computer system which may be employed to practice one or more embodiments set forth herein, or portions thereof.

FIG. 8 is an illustration of a scenario featuring an example non-transitory machine-readable medium in accordance with one or more embodiments set forth herein.

### DETAILED DESCRIPTION OF ILLUSTRATIVE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

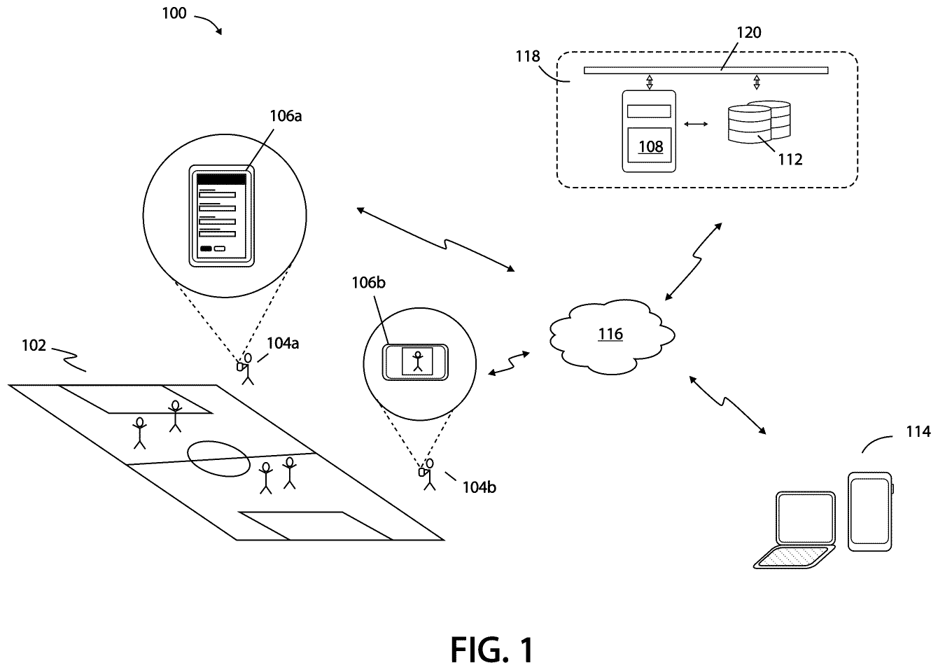

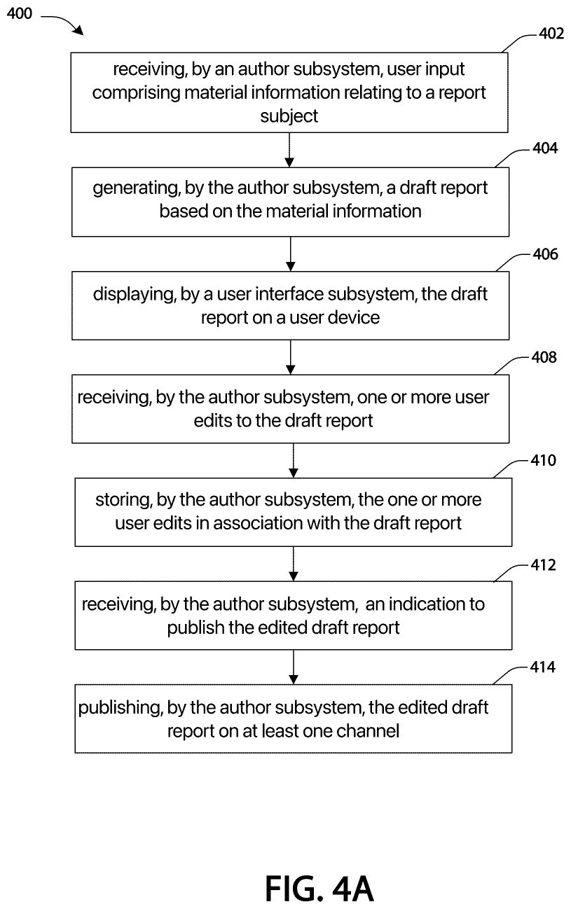

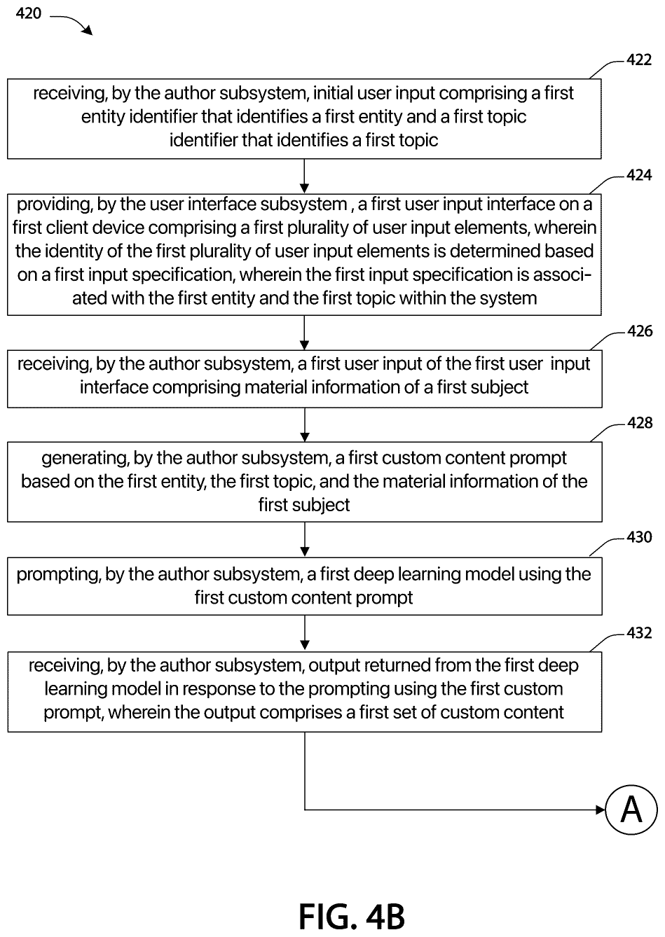

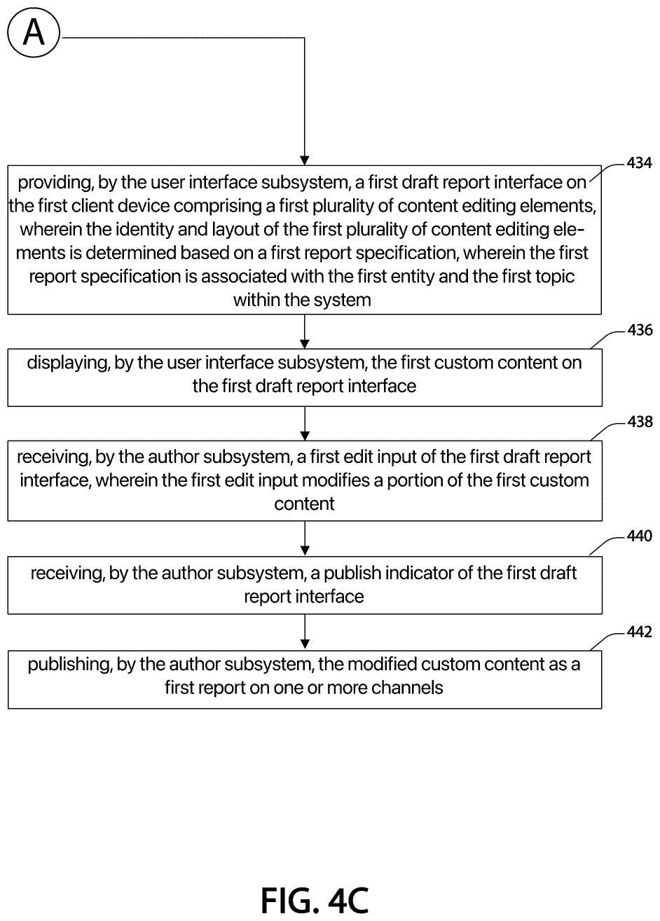

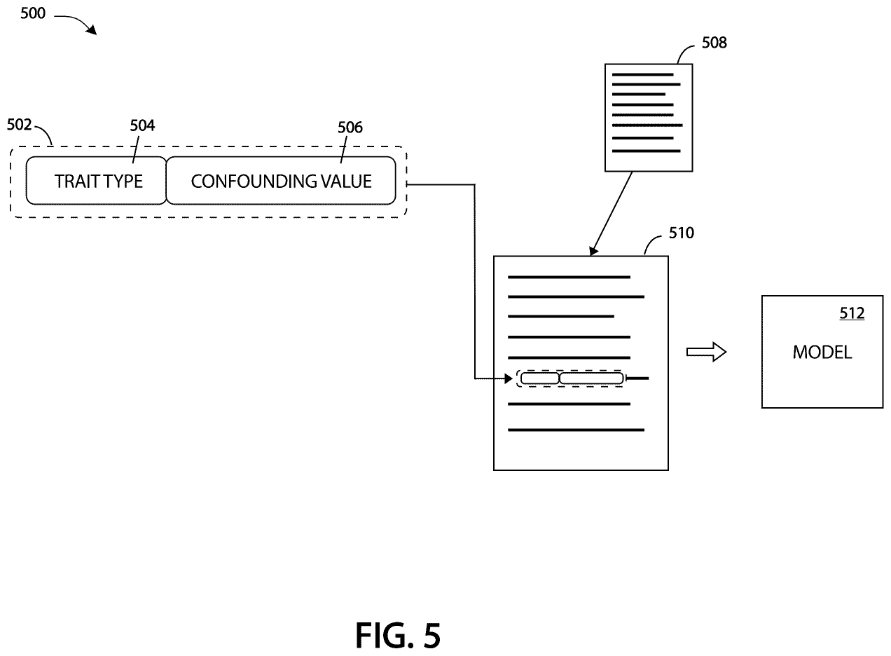

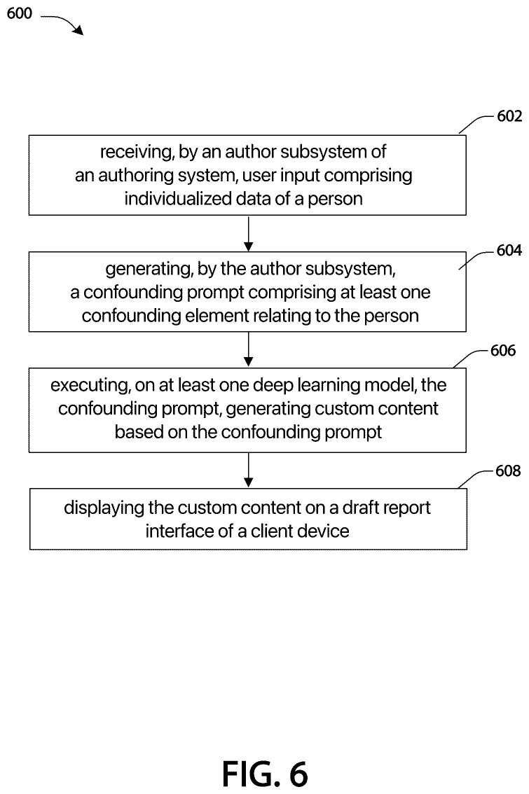

Certain non-limiting embodiments of systems and methods disclosed herein for generating content and reports (e.g., reports, audio clips, video clips, articles, etc.) using deep learning models based on user input are illustrated by example methods 400 and 420 of FIGS. 4A and 4B and are further described in conjunction with author system 100, portions of which are illustrated in FIGS. 1-3. Certain non-limiting embodiments of systems and methods disclosed herein that may protect personal identities from being inferred by deep learning models are illustrated by method 600 of FIG. 6 and are further described in conjunction with subsystem 500, portions of which are illustrated in FIG. 5.

With reference to FIG. 1, there is shown a non-limiting, exemplary scene 102 in which one or more exemplary embodiments of author system 100 may be utilized. In this example, scene 102 is a sports field (e.g., soccer field) in which one or more sporting events may take place, although generally any type of scene may be suitable for implementing the embodiments disclosed herein. As illustrated, one or more individual users 104 may observer scene/event 102. User 104 may use input device 106 to input at least one user input (e.g., observation, fact, note, transcript, video, image, etc.) relating to scene/event 102 in one or more user interfaces of the system provided on input device 106. In general, input device 106 may comprise any computing device capable of providing and/or supporting one or more user interfaces to a user, as described in more detail below.

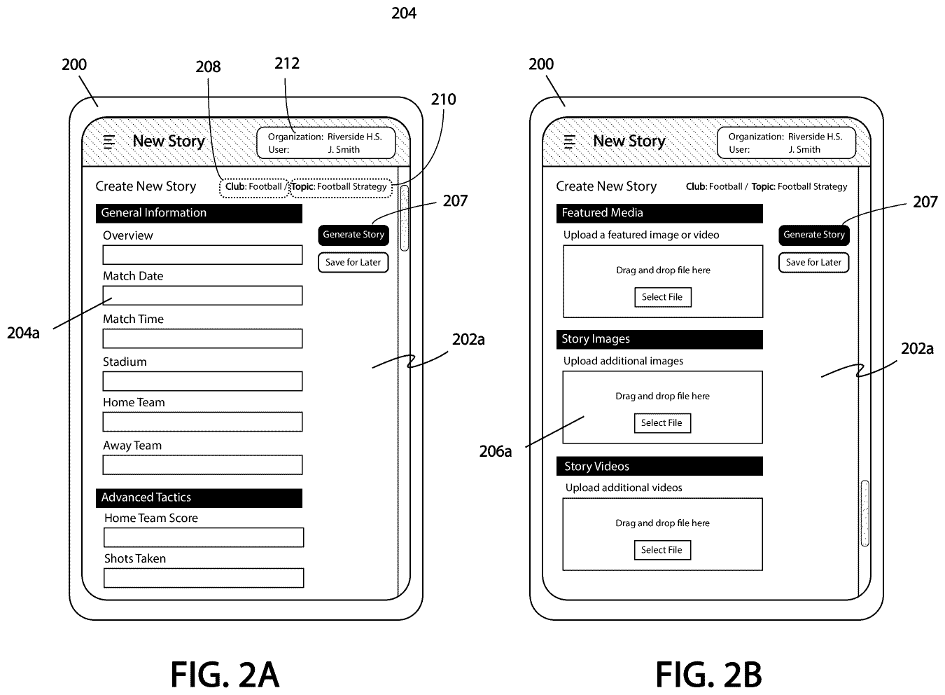

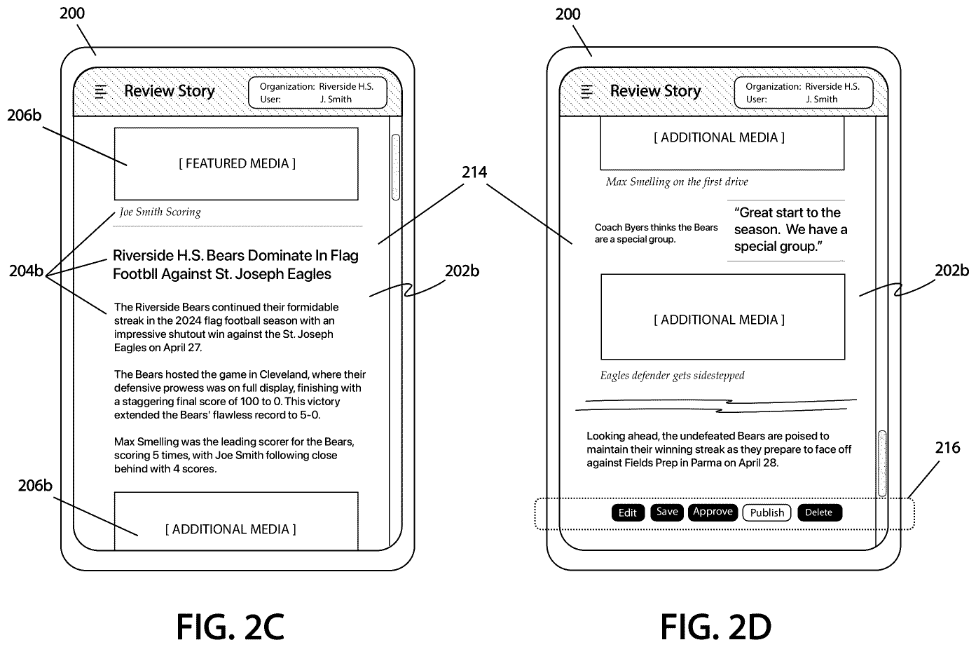

Note that a user generally means a human user, unless context dictates otherwise. In some embodiments, a user may be a human user who has information relating to a report subject-a person, place, thing or event about which a report may be generated by the system disclosed in the embodiments herein. In some embodiments, a user may be a human user who requests the system to generate a draft report by specifying one or more report parameters, such as report type and topic. In some embodiments, a user may be an administrator user or editor user. Note also that in some embodiments a user interface may comprise a graphical user interface of the system, such as non-limiting exemplary screens described below in relation to FIG. 2. In some embodiments, a user interface may comprise a voice and/or video interface of the system. In some embodiments, a user interface may comprise an API or service of the system for the one or more users, or for one or more pre-configured data sources.

With continuing reference to FIG. 1, author system 100 embodiments disclosed herein may include one or more servers 108 (e.g., application servers, services, model servers, AI servers, etc.) communicatively coupled with one or more data stores 112. In general, data store 112 may comprise any repository or subsystem (physical, virtual, or distributed) that may hold data for system 100 Including references to data on other systems) and that allows retrieval or access to that data, sufficient to support the functionality of the embodiments described herein. Date store 112 may comprise one or more underlying storage mechanisms—for example, databases or database tables, file system storage (files/folders), data lake or data warehouse repositories, in-memory data structures, or other data-holding mediums. In some non-limiting embodiments, data store 112 may comprise, for example, one or more relational databases (e.g., PostgreSQL, MySQL), noSQL databases (e.g., Firebase®, MongoDB®), vector databases, graph databases, flat files, memory caches, etc. In some non-limiting embodiments, data store 112 may comprise, for example, one or more data lakes, data warehouses/marts, object storage services (e.g., buckets), etc.

Some embodiments of system 100 may include one or more client devices 114. In some embodiments, client device(s) 114, server(s) 108, data store(s) 112, and/or input device(s) 106 may be communicatively coupled via one or more network(s) 116. Network(s) 116 may comprise the internet, intranets, extranets, local area networks (LANs), wide area networks (WANs), wired networks, wireless network (using wireless protocols and technologies such as, e.g., Wifi or cellular), or any other network suitable for providing data communications between two machines, environments, devices, networks, etc. In one or more embodiments, application server 108 and/or data store 112 may be implemented on networked dedicated host machines; in other embodiments, they may be hosted as services in one or more service environments 118, or a combination of dedicated host machines and service environments. In general, a service environment, such as service environment 118, may comprise cloud infrastructure, platform, and/or software providing various servers, databases, data stores, services, and the like.

Server(s) 108 and/or data store(s) 112 may host system 100 and/or backend portions 120 thereof. In general, system backend 120 may comprise one or more software applications, programs, hardware, firmware, components, code portions, frameworks, scripts, or modules, and the like, that are generally configured to provide backend functionality, server to client functionality, and/or web application functionality, to one or more additional software applications, programs, components, code portions, scripts, stores, screens, interfaces, or modules, and the like (not shown), provided by, running on, or hosted on one or more user devices (e.g., input device 106, client device 114). For example, in some exemplary embodiments, the aforementioned one or more additional software applications, programs, components, etc. may be configured to display one or more graphical user interfaces or screens (e.g., screens 204a-d) (e.g., via an app, via a web browser for a web application backend), as further described below.

In general, system 100 may comprise one or more applications deployed on service environment 118 that are configured to author content and reports that are based on, incorporate, and/or are inspired by human user input concerning a report subject (person, place, thing, and/or event). The terms “content” and “custom content” may generally refer to deep learning model output, and “report”, “article,” and “story” may generally refer to system output (e.g., system 100 output) such as, e.g., published articles, reports, marketing pieces, social media posts, blog entries, and/or informational articles, stories, etc., including but not limited to sports-related news and stories. The terms “human user input” and “user input” may refer to a human-originated expression, in any multimodal form, input to system 100 via one or more user interfaces. It may be appreciated that human-originated expression may encompass data feeds, media feeds, streams, etc. that communicate information, such as box scores, statistics, social media updates, etc. regarding a report subject that originate directly or indirectly from a human. It may be appreciated that human user input and user input may encompass textual expression conveying one or more facts, observations, or comments of or relating to a report subject, and/or images, videos or audio recordings of or relating to a report subject.

In some embodiments, author system 100 may be configured to provide one or more user interfaces. The one or more user interfaces may be configured to enable a user (e.g., user 104) to provide user input to backend 120, display draft reports, enable a user to edit draft reports, enable a user to administer accounts and/or other users or instances, enable a user to validate or approve for publication draft reports, and/or enable a user to publish or distribute reports on one or more channels (e.g., Instagram®, Facebook®, X, via a URL link, via a website, etc.), etc. In general, the one or more user interfaces may be architected, implemented and/or configured in any suitable manner sufficient to provide the functionality disclosed herein. Some non-limiting examples of user interfaces may include graphical user interfaces (screens), voice user interfaces, cameras, etc.

With reference to FIGS. 2A-2D, shown is device 200, an exemplary, non-limiting embodiment of input device 106. In some embodiments, device 200 may be iPhone, iPad, Android, laptop, etc. As shown, device 200 may provide one or more screens 202a,b, which are exemplary, non-limiting embodiments of graphical user interfaces of system 100, according to one or more embodiments. As may be seen, screens 202a,b may be configured to allow a user to provide user input to backend 120 and to edit a draft report (e.g., the draft report displayed on screen 202b).

In some embodiments, the one or more user interfaces may be provided as one or more web pages running in a web browser having elements that enable a user to upload user input (e.g., text, video, image and/or audio) to backend 120. In some embodiments, the one or more user interfaces may be provided as an app or other code executing on a mobile device operating system (e.g., Swift® apps for iPhone or iPad) having elements that enable a user to provide or upload user input (e.g., text, video, image and/or audio) to backend 120. While specific embodiments of graphical user interfaces are described and shown in FIGS. 2A-2D, the reader will appreciate that any suitable graphical user interfaces, layouts, interface elements, user input, designs, etc. sufficient to accomplish the functions described herein may be employed and still be within the scope of the embodiments herein.

With continued reference to FIGS. 2A-2D, using screen 202 user 104 (e.g., coach, manager, fan, scout, reporter, teacher, statistician, student, observer, official, etc.) may, using text fields 204 or other input elements (e.g., file upload elements 206), provide user input to backend 120. In some embodiments, system 100 may be configured such that one or more input elements of a user interface (e.g., screen 202) may be prepopulated from stored information (e.g., in one or more entity or user datasets, described below); in some embodiments, system 100 may be configured such that one or more input elements of a user interface (e.g., screen 202) must be completed by a user (e.g., populated with material information) before a report may be generated.

In general, author system 100 may be configured to support entity users and/or individual users, and to store, update and maintain one or more datasets relevant to each user, described in more detail below. In some embodiments, system 100 may be configured to support one or more user groups and/or individual users that are children to a parent entity user. In some non-limiting examples, system 100 may be configured to support one or more organizations as parent entity users (e.g., school districts, businesses, community groups, etc.), where each parent entity may have at least one child entity/group (e.g., school, business division, local chapter, etc.), and in some embodiments may have additional nested child entities/groups (e.g., school club, business site, individual users, etc.). With reference to the non-limiting embodiment illustrated in FIG. 2A, it is evident that system 100 in that example has been configured to provide for school entity users (e.g., organization 212/Riverside H.S.) that have at least two child entities/groups—a club group (e.g., football) and individual users (e.g., J. Smith).

In some embodiments, system 100 may be configured to provide one or more user interfaces (e.g., one or more screens, one or more GUI elements, etc.) (not shown) that allow a user to select or identify one or more report parameters that may generally determine within the system the class of report to be generated by the system. As may be appreciated, system 100 may be configured to provide for generally any suitable report parameter(s) sufficient to determine within the system the class of report to be generated by the system. Also as may be appreciated, system 100 may be configured such that a user (e.g., a parent entity user) may pre-configure and/or customize the report parameters to be utilized by the user's system instance to determine the class of report to be generated by the system. For example, in some non-limiting embodiments, system 100 may be configured to receive a type and topic parameter from a user and thereby determine the class of report to be generated by system 100. With reference to the non-limiting embodiment illustrated in FIG. 2A, it is evident by type indicator 208 and topic indicator 210 that a user or administrator has selected to generate a “football/football strategy” report class.

In general, system 100 may be configured such that each report class may be associated with a report specification. A report specification may generally comprise any suitable report definition, form, etc., sufficient to specify the information to be provided in a draft report in the embodiments described herein. In general, system 100 may be configured such that each report class may be associated with an input specification. An input specification may generally comprise any suitable input definition, form, etc., sufficient to specify the information to be requested from one or more users for the purpose of generating a draft report of the associated report class.

In general, system 100 may be configured such that report specifications and input specifications may be customized and/or customizable by users (e.g., entity users) and indexed and/or otherwise associated with report parameters (e.g., type and topic). In some embodiments, system 100 may be configured to provide one or more user input interfaces (e.g., screen 202a) to receive user input based on an associated input specification. In some embodiments, system 100 may be configured to provide one or more draft report interfaces (e.g., screen 202b) to display and edit custom content and otherwise receive user input (e.g., new images, new text) based on an associated report specification. For example, in some embodiments, system 100 may be configured to provide one or more user input and/or draft report interfaces (e.g., screen 202a,b) associated with the report parameters for the user (e.g., based on the input and report specifications associated with report parameters for that user). For example, with reference to exemplary screen 202a in FIG. 2, it is evident that an input specification (not shown) associated with that user input interface screen (e.g., a football strategy user input screen for Riverside H.S. football club) specifies the user input information indicated by interface elements 204a (e.g., overview, match date, match time, etc.). Likewise for exemplary draft report interface screen 202b in relation to a report specification (not shown) associated with that screen (e.g., a football strategy draft report screen for Riverside H.S. football club).

In general, in system 100 embodiments, a report specification and/or input specification may be configured to require specified information to be received from a user before custom content and/or draft report may be generated by system 100—such information referred to herein as material information. In general, material information associated with a report may include at least user input information needed to generate suitable custom content by system 100, which may depend on factors such as user preference, prompt design, deep learning model characteristics, etc. For example, with reference to the exemplary embodiment of FIG. 2, system 100 may be configured in that embodiment such that one or more of the user elements 204a (e.g., match date) are required to receive material user input before a draft report may be generated.

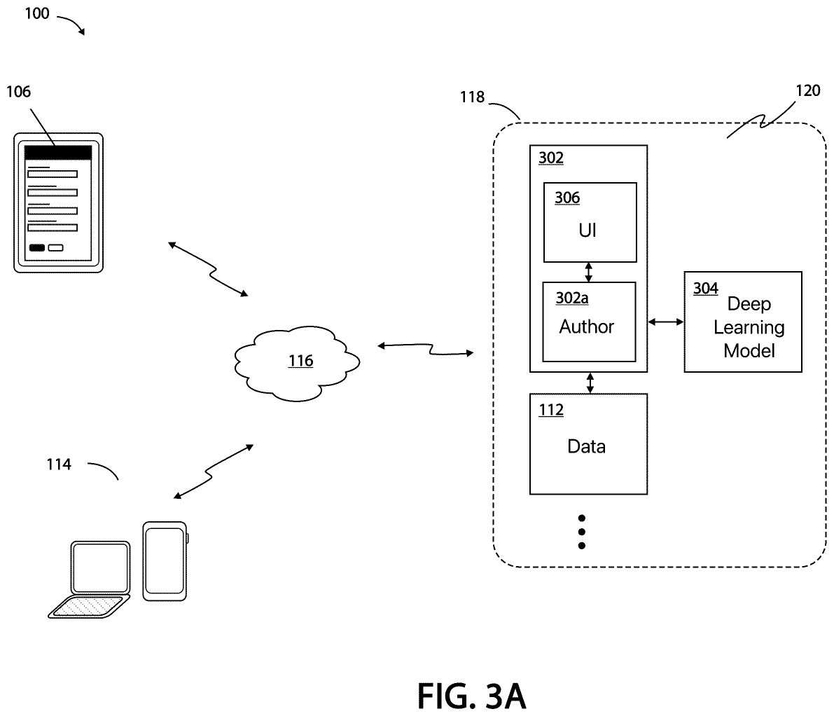

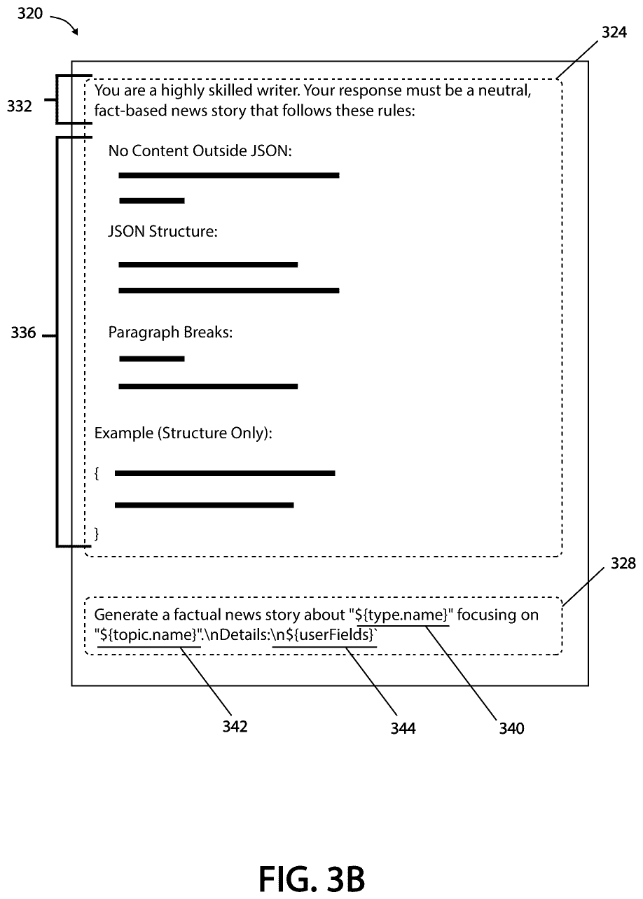

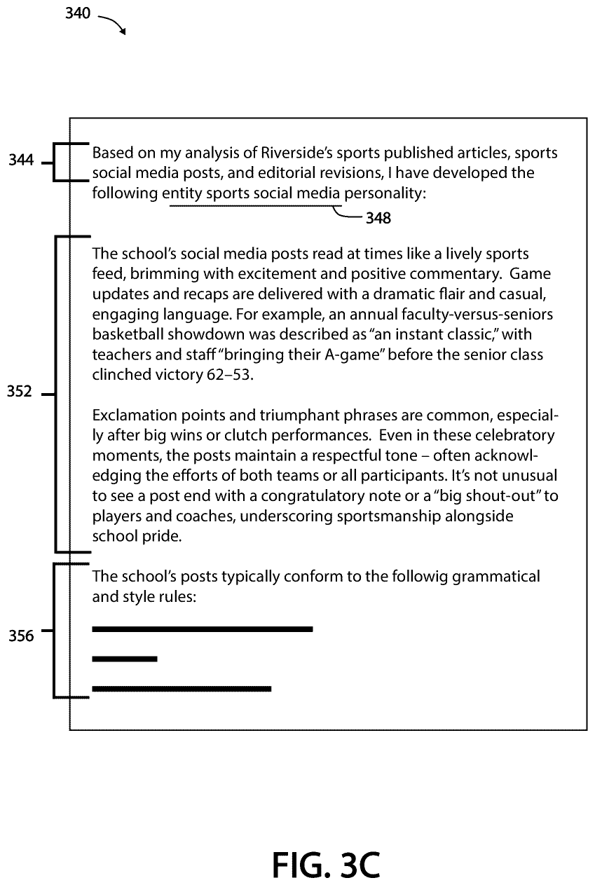

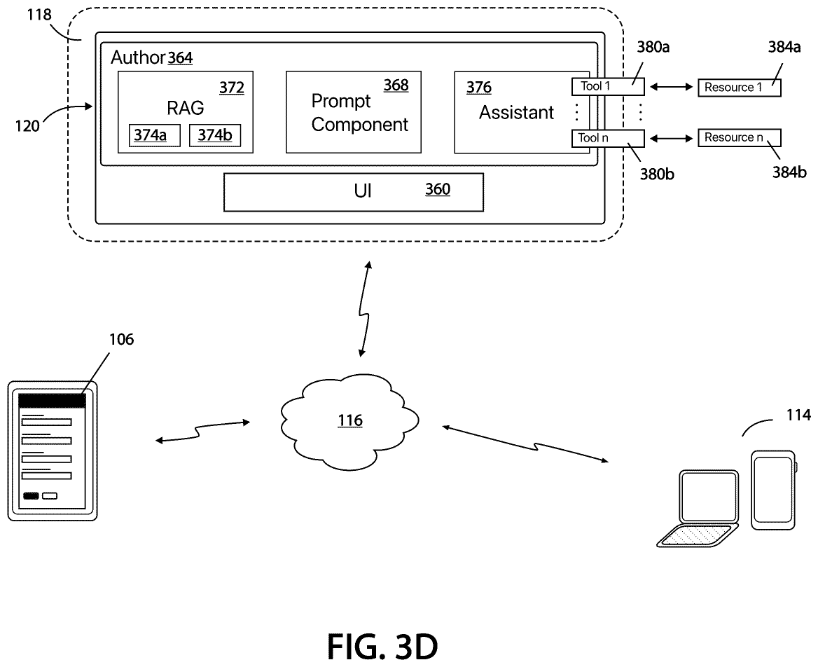

With continued reference to FIG. 2, a user may input information about a report subject (here, a football event) by, for example, inputting all or a portion of the information elicited by the one or more user interface elements (e.g., text fields 204a upload elements 206a, etc.). Using the user input interface (e.g., screen 202a), a user may initiate generation of custom content and reports by system 100 (e.g., by backend 120), as described in more detail below in relation to FIG. 3. For example, in the embodiment shown, a user may interact with a screen element (e.g., button 207) configured to initiate such custom content and draft report generation by system 100.

In general, system 100 may be configured such that data store 112 may comprise one or more datasets supporting the functionality of the embodiments disclosed herein. A dataset may generally comprise any collection of data and information related or linked in a manner suitable for use in the system of the embodiments described herein. A dataset may comprise data in any form, whether structured or unstructured, and grouped for use or analysis by system 100. In some embodiments, datasets may be federated and/or centralized. All or portions of individual datasets may be pre-processed by system 100 for use in one or more operations or activities, such as in generating and supporting user interfaces, constructing prompts, and all or portions of individual datasets may be stored raw, such as, for example image or video buckets.

In some embodiments, data store 112 may comprise one or more entity datasets. Generally, an entity dataset may comprise any dataset associated by system 100 with an entity. In some embodiments, entity datasets may comprise one or more of: entity information, input specification information, report specification information, user input information, final publications of an entity, draft publications of an entity, final and draft publication paired sets of an entity, archived editing operations from an entity user (e.g., editor, reviewer, etc.), curated sets of entity publications, house style guidelines, prompt information, prompts relating to an entity, entity personas, entity persona datasets, etc.

In some embodiments, data store 112 may comprise one or more user datasets. Generally, a user dataset may comprise any dataset associated by system 100 with an individual human user. In some embodiments, user datasets may comprise one or more of: individual user information, input specification information, report specification information, user input information (of an individual user), final publications of an individual user, draft publications of an individual user, final and draft publication paired sets of an individual user, archived editing operations from an individual user, curated sets of individual user publications, prompt information, prompts relating to an individual user, individual user personas, user persona datasets, etc.

With continued reference to FIG. 2, in some embodiments, system 100 may be configured such that all or a portion of the information elicited from users via a user input interface (e.g., screen 202a) may be supplied/referenced/provided by data present in one or more relevant datasets. For example, in some embodiments, system 100 may be configured to pre-populate one or more of a user input screen elements (e.g., elements 204a, 206a) with data present in a relevant dataset (e.g., an entity dataset), if present, and/or dynamically disable or remove any such input screen elements. So, for example, with reference to the non-limiting exemplary user input interface 202a shown in FIG. 2, and assuming an instance of system 100 that has presently stored team schedule information in a relevant entity dataset (e.g., a Riverside H.S. dataset, a Riverside Football dataset, etc.), one or more user interface elements 204a (e.g., “Match Date”, “Home Team”, “Away Team”, etc.) may be pre-populated and/or dynamically removed from user interface 202a.

In general, system 100 may be configured to incorporate generated custom content into a draft report and provide the draft report to a user (e.g., an administrator or editor user) for reviewing, editing, approval and/or publishing. Generally any manner and architecture for post-processing deep learning model output suitable to build a draft report sufficient to provide the functionality described herein may be utilized in the embodiments. For example, in some non-limiting embodiments, deep learning model output may be parsed or otherwise received by system 100 (e.g., backend 120) and processed by performing one or more operations such as text normalization, structural formatting, and templating. Operations such as templating may be pre-configured by a user (e.g., an entity user) and/or pre-configured based on selected topic.

In some embodiments, author system 100 may be configured to provide one or more draft report interfaces that enable a user, such as an administrator or editor, to perform one or more edit operations. In general, a draft report interface may comprise a user interface (e.g., graphical user interface, editor interface) comprising one or more content editing elements (e.g., text elements, image frames, editing tools, etc.). In the non-limiting example illustrated in FIGS. 2C and 2D, a draft report (e.g., draft report 214) may be displayed via a draft report interface (e.g., screen 202b). As indicated by control elements 216, editor screen 202b may be configured so that a reviewer may edit, save, approve, publish or delete a draft report, although additional and/or different functions may be provided in the embodiments described herein. Using a draft report interface of system 100 (e.g., screen 202b), an editor user may make one or more edits to a draft report (e.g., draft report 214). As may be seen, in this embodiment, system 100 has templated draft report 214 to include one or more media frames 206b (e.g., images or video) that may include user upload functionality, which may in some embodiments be initially populated by media provided or selected by a deep learning model as custom content and/or included as selected by a user or editor, and text elements 204b as captions, body text, block quotes, etc., all or substantial portions of which may be generated as custom content by the deep learning model. In this non-limiting embodiment, a reviewer may edit draft report 214 by, for example, making changes to the text, changing or editing media (e.g., cropping), making format changes, etc. In this embodiment, a reviewer may save the draft article, approve it for later workflow (e.g., later publication) or publish the draft article. As may be appreciated, one or more publication channels may have been pre-configured in system 100 for the reviewer's account and/or the reviewer's entity account, etc. Additionally and/or alternatively, system 100 may be configured to allow a reviewer to directly set the publication channel.

In some embodiments, system 100 may be configured to store user edits, document user editing behavior, and/or characterize user style preferences based on editing behavior. For example, in some embodiments, system 100 may be configured to store a copy of both a draft report (e.g., draft report 214) along with the edited/modified version of the draft report (e.g., the published version). Alternatively and/or additionally, in some embodiments system 100 may be configured to store data relating to edit operations (e.g., edit operation descriptors) performed by a user in relation to a published report. As described in more detail below, such stored user edit information may be utilized by system 100 to build knowledge concerning individual users and/or entities' style and preferences concerning voice, grammar, tone, etc. Also as described in more detail below, system 100 may be configured to utilize such stored knowledge to, e.g., improve deep learning model prompting (custom content generation) and/or post-processing of custom content to build draft reports.

With continued reference to FIG. 2, in some embodiments, system 100 may be configured such that a portion of the information provided in a draft report (i.e., information other than custom content information) may be supplied/referenced/provided by data present in one or more relevant datasets. For example, in some embodiments, system 100 may be configured to populate and/or make accessible to one or more of a draft report screen elements (e.g., elements 206b) with data present in a relevant dataset (e.g., an entity dataset), if present. So, for example, with reference to the non-limiting exemplary draft report interface 202b shown in FIG. 2, and assuming an instance of system 100 that has presently stored relevant media in a relevant entity dataset (e.g., a Riverside H.S. dataset, a Riverside Football dataset, etc.), one or more user interface elements 206b may be populated and/or have accessible to it relevant stored media. In some embodiments, such relevant stored media may originate from any suitable sources, such as (for example) social media feeds, other system users, etc.

Reference is now made to FIG. 3A, another illustration of system 100 according to one or more embodiments disclosed herein. In particular, backend portion 120 is illustrated in a block diagram to further describe certain aspects. As previously mentioned, backend 120 may be architected or implemented in generally any suitable manner sufficient to provide the functionality described herein. For example, backend 120 may be architected fully or partially as a web application involving one or more modules, components, code portions, frameworks, services, microservices, etc.

Referring to FIG. 3A, backend portion 120 may comprise author subsystem 302. In general, author subsystem 302 may be implemented in generally any suitable manner sufficient to provide the functionality described herein. For example, author 302 may comprise one or more related modules, components, code portions, frameworks, services, microservices, middleware, etc. configured to interact with one or more deep learning models, such as deep learning model 304, and to generate reports incorporating custom content generated by the one or more deep learning models. For example, in some embodiments, author 302 may be configured to comprise code portions, etc., directed to interacting with a deep learning model (e.g., author component 302a) and other code portions, etc. directed to constructing draft reports (UI subsystem 306). In general, deep learning model(s) 304 may comprise self-hosted and/or connected external deep learning models. In some embodiments, the one or more deep learning models may comprise one or more large language and/or a multimodal models. In some embodiments, the one or more deep learning models may comprise one or more transformer-based large language and/or multimodal models. In some embodiments, the one or more deep learning models may comprise one or more services from, e.g., OpenAI (e.g., GPT series, CLIP), DeepSeek (e.g., R1), Anthropic (e.g., Claude series), Meta (e.g., Llama series), Cohere (e.g., Command), AI21 Labs (e.g., Jurassic), xAI (e.g., Grok series), etc.

As shown in FIG. 3A, backend 120 may comprise data store 112. In some embodiments, data store 112 may comprise one or more datasets supporting the functionality of the system embodiments disclosed herein, as described above in relation to FIGS. 1 and 2.

In some embodiments, data store 112 may comprise one or more entity persona datasets (not shown). In general, an entity persona dataset may comprise any suitable dataset sufficient to allow for an entity author persona, as described below in relation to FIG. 3C, to be generated for an identified entity by a deep learning model, as used in some embodiments described herein. In some embodiments, the one or more entity persona datasets may comprise previously generated entity author personas, one or more previously generated entity author personas based on report type and/or topic for a particular entity, custom entity author personas (e.g., supplied by the entity or third party), one or more entity publications and/or published reports, entity style guidelines, etc. In some embodiments, the one or more entity persona datasets may comprise final and draft publication paired sets of an entity, archived editing operations from an entity user (e.g., editor, reviewer, etc.), curated sets of entity publications, and/or house style guidelines, etc.

In some embodiments, data store 112 may comprise one or more user persona datasets. In general, a user persona dataset may comprise any suitable dataset sufficient to allow for an individual user author persona, as described below, to be generated by a deep learning model, as used in some embodiments described herein. In some embodiments, the one or more user persona datasets may comprise previously generated individual user author personas, one or more previously generated individual user author personas based on report type and/or topic for a particular individual user, custom user author personas (e.g., supplied by the user or third party), one or more individual user publications and/or published reports, etc., In some embodiments, a user persona dataset may comprise final and draft publication paired sets of the individual user, archived editing operations from the individual user, curated sets of individual user publications, and/or user style guidelines, etc.

With reference to FIG. 3A, deep learning model 304 may generally be prompted to generate custom content for use in system 100 in any suitable manner sufficient to provide the functionality disclosed herein. In some non-limiting embodiments, backend 120 (e.g., author subsystem 302) may be configured to construct one or more custom content prompts and use it to prompt deep learning model 304 to generate custom content. In some embodiments, the one or more custom content prompts may be based on or incorporate data from an entity dataset and/or a user dataset. In general, a prompt (e.g., a custom content prompt, an entity author persona prompt, a user author persona prompt, etc.) constructed and used in the embodiments disclosed herein may be generally any text and/or multimodal single or multi-stage prompt sufficient to cause a deep learning model (e.g., model 304) to generate suitable content for use in the embodiments. In some embodiments, a prompt may comprise one or more of a system instruction/portion, a task instruction/portion; a user input (context) instruction/portion; and/or an output formatting instruction/portion. Some embodiments may use one or more of the aforementioned instructions or portions, and/or may combine one or more instructions or portions, as the case may be. In some embodiments, a prompt may comprise a chat-style API prompt comprising a system role and a user role.

Reference is now made to FIG. 3B, illustrating a non-limiting example of a custom content prompt 320 for use in some of the embodiments disclosed herein. As shown, custom content prompt 320 may be a chat-style API prompt comprising a system role portion 324 and a user role portion 328. In general, a system role portion may comprise one or more statements or instructions relating to expertise, persona, and/or style for the deep learning model (e.g., model 304) to adopt in generating custom content. In some embodiments, system role portion 324 may comprise one or more author persona portions 332 and one or more output formatting portions 336.

In some embodiments, system 100 may be configured to construct custom content prompts using author persona portions that are associated by the author system (system 100) with report classes (e.g. report type/topic). For example, in some embodiments of system 100, a custom content prompt constructed for a first report class (e.g., football, football strategy, etc.) may comprise a first author persona portion and a custom content prompt constructed for a second report class (e.g., baseball, baseball strategy, etc.) may comprise a second author persona portion that is different than the first author persona portion.

In some embodiments, system 100 may be configured to construct custom content prompts using author persona portions that may include (e.g., by direct incorporation, by reference, etc.) one or more entity or user author personas (as described below in relation to FIG. 3C), or portions thereof.

Referring still to FIG. 3B, a user role portion (e.g., portion 328) may generally comprise one or more statements or instructions instructing the one or more deep learning models (e.g., model 304) to generate custom content about a report subject based on user input. In some embodiments, system 100 may be configured to construct custom content prompts using user role portions that are associated by the system with report classes (e.g. report type/topic). For example, in some embodiments of system 100, a custom content prompt constructed for a first report class (e.g., football, football strategy, etc.) may comprise a first user role portion and a custom content prompt constructed for a second report class (e.g., baseball, baseball strategy, etc.) may comprise a second user role portion that is different than the first user role portion.

In some embodiments, system 100 may be configured to construct custom content prompts about a report subject that may include (e.g., by direct incorporation, by reference, etc.) user input information about the report subject. For example, in some embodiments of system 100, user role portion 328 may comprise one or more statements instructing the one or more deep learning models (e.g., model 304) to generate custom content (story, report, social media post, etc.) about the report subject and provide user input information relating to the report subject. With reference the embodiment shown in FIG. 3B, as may be seen, prompt 320 has been constructed by system 100 to include system role portion 328 comprising report parameter identifying information (e.g., type reference 340 and topic reference 342) (e.g., Riverside H.S. football>football strategy) as well as user input information about the report subject (via user input reference 344). As may be appreciated, in some embodiments, all or a portion of the user input information may be stored and accessed from one or more relevant datasets (e.g., entity datasets). Also, as may be appreciated, in some embodiments user input information may comprise user input information from a one or a plurality of users.

Referring again to FIG. 3A, deep learning model 304 may generally be prompted to generate entity author persona prompts and/or user author persona prompts for use in system 100 in any suitable manner sufficient to provide the functionality disclosed herein. In some non-limiting embodiments, backend 120 (e.g., author subsystem 302) may be configured to construct one or more entity author persona prompts and/or one or more user author persona prompts to prompt deep learning model 304 with; in some embodiments, the one or more entity author persona prompts may be based on or incorporate data from an entity author persona dataset. In some embodiments, the one or more user author persona prompts may be based on or incorporate data from a user author persona dataset.

With reference to FIG. 3C, a non-limiting example of an entity author persona 340 is illustrated. In general, an entity author persona may comprise a natural language string and/or multimodal prompt instruction that describes an entity author in a manner such that a deep learning model may utilize it as personality context (e.g., system message, output formatting instruction and/or context, etc.) in generating custom content that conforms to a target entity's house style (e.g., a target entity's tone, voice, formatting, and/or linguistic choices, etc. that define the organization's published output). In the embodiment shown, entity author persona 340 may comprise persona context suitable for use in a system portion of a chat-style API prompt. For example, entity author persona 340 may comprise a body portion 352 that generally describes the entity's style and tone, as well as a portion 352 that generally describes and/or specifies an entity's style and grammar rules. In general, an entity author persona as used herein may correspond to an entity's overall/general house style, or correspond to an entity's house style with respect to a subset of report types and/or topics. For example, in the embodiments shown, as indicated by introductory section 344, entity author persona 340 corresponds to the entity's house style as it relates to sports social media posts. As may be appreciated from section 344, entity author persona 340 was generated based on a subset of the entity's entity author persona dataset (i.e, the entity's published articles, sports social media posts, and editorial revisions).

Similar to an entity author persona, a user author persona (not shown) may generally comprise a natural language string and/or multimodal prompt instruction that describes a user author in a manner such that a deep learning model may utilize it as persona context (e.g., system message, output formatting instruction and/or context, etc.) in generating custom content that conforms to a target user's author style (e.g., a target user's tone, voice, formatting, and/or linguistic choices, etc. that define the user's published output). In some embodiments, a user author persona may comprise persona context suitable for use in a system portion of a chat-style API prompt. For example, in some embodiments a user author persona may comprise a body portion that generally describes the user's style and tone, as well as a portion that generally describes and/or specifies the user's style and grammar rules. In general, a user author persona as used herein may correspond to a user's overall/general author style, or correspond to a user's author style with respect to a subset of report types and/or topics (e.g., sports social media posts). As may be appreciated a user author persona may be generated based on a subset of a user author persona dataset (e.g., the user's published articles, sports social media posts, and editorial revisions).

With continued reference to FIG. 3A, backend 120 (e.g., author subsystem 302) may be configured to receive output from one or more deep learning models (custom content, as prompted by a custom content prompt) and generate draft reports incorporating custom content generated by the one or more deep learning models (e.g., model 304), as further described above in relation to FIG. 2. In some embodiments, backend 120 (e.g., user interface subsystem 306) may be configured to provide one or more draft report interfaces (e.g., screen 202b) on one or more client devices (e.g., devices 106, 114, 200) to display and provide the draft reports, as further described above in relation to FIG. 2.

In general, backend 120 (e.g., user interface subsystem 306) may populate a draft report interface (e.g., screen 202b) with custom content in any suitable manner sufficient to provide the functionality of the embodiments described herein. As mentioned above, in some embodiments, backend 120 may parse, template, etc. the custom content to display the custom content in a draft report (e.g., in a draft report interface, such as screen 202b). In some embodiments, the custom content prompt may be constructed to provide relevant report specification information (e.g., formatting information, content editing element information, etc.) to the deep learning model (e.g., model 304), and requested to provide custom content output in a manner that assists backend 120 with templating or otherwise displaying the custom content. For example, in some embodiments, the custom content prompt may be constructed to task the deep learning model to label the custom content in a manner that assists backend 120 with templating or otherwise displaying the custom content.

Reference is now made to FIG. 3D, a block diagram illustrating another exemplary embodiment of system 100. In general, in some embodiments, backend 120 may be configured to interface and/or interact with one or more client systems or devices, such as for example, client devices 106, 114, 200. Backend 120 may comprise author subsystem 364, which may be implemented in generally any suitable manner sufficient to provide the functionality described herein, in the same manner as described above in relation to author subsystem 302. For example, as stated above, author 364 may comprise one or more related modules, components, code portions, frameworks, services, microservices, middleware, etc. configured to interact with one or more deep learning models (not shown) and to generate reports incorporating custom content generated by the one or more deep learning models. In general, the deep learning model(s) may comprise self-hosted and/or connected external deep learning models. In some embodiments, the one or more deep learning models may comprise one or more large language and/or a multimodal models, as described above in relation to deep learning model 304.

In general, author subsystem 364 may be configured to generate custom content (e.g., natural language-based content, multimodal content, etc.) that incorporates, is based on, and/or is inspired by material information input by a human user, such as, for example, material information input using one or more user input interfaces (e.g., screen 202a) of the system disclosed in some embodiments herein. In general, material information is related to a report subject (person, place, thing or event) and is generally further described above in relation to FIG. 1-2.

In some embodiments, backend 120 may be configured to include a user interface layer or subsystem, such as user interface subsystem 360 in FIG. 3D. User interface subsystem 360 may generally be configured and function as described above in relation to user interface subsystem 306.

In some embodiments, author subsystem 364 may comprise a prompt component/subsystem 368. In general, prompt component 368 may be configured in any suitable manner sufficient to allow author system 100 (e.g., backend 120) to prompt or otherwise interact with and/or interface with the one or more hosted or external deep learning models to generate custom content based on user input. In general, a prompt constructed and used in the embodiments disclosed herein may be generally any text and/or multimodal single or multi-stage prompt sufficient to cause a deep learning model to generate suitable content for use in the embodiments, as described above. in some embodiments, prompt component 368 may be configured to construct one or more custom content prompts, entity author persona prompts, user author persona prompts, etc. In some embodiments, the one or more custom content prompts may be based on or incorporate data from a relevant entity dataset and/or a user dataset. For example, in some non-limiting embodiments, prompt component 368 may be configured to create and provide the deep learning model(s) one or more custom content prompts that are pre-configured (e.g., fully or partially templated) and/or static system prompts that comprises a system instruction directing the deep learning model(s) to adopt a role as an author with a specified authoring style and/or to otherwise instruct the model(s) as to authoring parameters and data, and to create custom content (e.g., write a story) based on at least material information input by one or more human users. Note that the foregoing instruction is not to be understood as a verbatim instruction, but rather a description of the instruction. Also, note that, the one or more pre-configured and/or static system prompts may comprise one or more instructions or prompt section(s) that are part of one or more prompts. In some embodiments, a prompt herein may comprise a chat-style API prompt comprising a system role and a user role, such as those non-limiting embodiments described above with reference to FIGS. 3A-3C.

Additionally and/or alternatively, in some embodiments, author subsystem 364 may comprise a “retrieval and generation” (RAG)-type large language model component 372. In general, RAG-type models may be fine-tuned using one or more indexed, particular model data sources by being configured to use those particular data sources as context in generating a response to a prompted task or query. In some embodiments, component 372 may be fine-tuned using one or more RAG data source 372 (illustrated in FIG. 3D as two indexed data sources 374a,b). Note that, as used herein, a RAG data source may comprise generally any corpus or set of human-authored content (including text or multimodal information—e.g., podcasts, video interviews, etc. that have been tokenized), indexed in any suitable manner. For example, in some non-limiting embodiments, an instance of the system may be provided that may have loaded one or more RAG data source (e.g., source 374a,b) comprising historical news, marketing, and/or informational articles authored by, e.g., one or more predefined sources (e.g., New York Times, Outkicked®, local school publications such as the Ignatian Eye™, Sports Illustrated®, etc.), and/or by one or more identified human authors (e.g., Ernest Hemingway, Peter King, Joseph Heller, etc.). In some embodiments, the entity data set(s), entity persona data set(s), user data set(s), and/or user author persona data set(s) may comprise one or more of the RAG data source(s), and vice versa. In some embodiments, author subsystem 364 may be configured to retrieve, after receiving at least one user input, relevant content from the RAG data source(s). In some embodiments, author subsystem 364 (e.g., component 372) may be configured to generate draft reports by generating one or more prompts using relevant content from a data source (e.g., source 374a,b) as context and the at least one user input in a task or query, and prompting the deep learning model(s) using the one or more prompts.

Additionally and/or alternatively, in some embodiments, author subsystem 364 may comprise and/or interface with an assistant 376 that is configured to perform one or more tasks, including editing and/or governance (legal compliance) tasks, in relation to a draft report generated by author subsystem 364 (e.g., the draft report displayed on screen 202b in FIG. 2). In general, large language models may be configured in systems to function as assistants or agents (terms used interchangeably herein) depending on, e.g., the manner of prompting. For example, assistants may be configured to operate with/using Chain-of-thought (CoT, Reason Only) prompts, Act-only prompts, ReAct (Reason+Act) prompts, etc. In some embodiments, assistant 376 may itself use one or more tools (e.g., tools 380) to assist it in performing its task(s) by performing one or more functions using, in some embodiments, data or functionality from one or more environments (e.g., resource 384). Notably, the one or more tools may themselves call one or more deep learning models, code, etc. to assist them in performing their functions.

With reference now to FIG. 4A, a method 400 of generating reports using deep learning models based on user input is detailed, according to one or more embodiments disclosed herein. Note that references to specific subsystems may be generally understood to be references to backend 120, depending on embodiment architecture. Note also that references to a user interface or UI subsystems may be generally understood to be references to an author subsystem, and vice versa, depending on embodiment architecture.

At 402, an author subsystem (e.g., backend 120, author 302, 364) of an author system of the embodiments described herein (e.g., system 100) may receive user input comprising material information relating to a report subject. In general, a report subject may comprise generally any person, place, thing or event. User input, including material information relating to a report subject, may be received via one or more user interfaces, as described above in relation to FIGS. 1-3.

At 404, the author subsystem may construct a draft report based on the material information. In general, in some embodiments, the author subsystem may construct a custom content prompt using stored information relating to the entity and/or individual user requesting the report and based on at least a portion of the user input, including the material information relating to the report subject. Stored information may comprise author persona information relating to the user. In some embodiments persona information may comprise a previously-generated entity author persona or user author persona. Prompts and custom prompts as constructed and used in the embodiments disclosed herein are further described above in relation to FIGS. 1-3. The author subsystem may prompt one or more deep learning models (e.g. model 304) with the custom content prompt and receive the output therefrom, which comprises custom content. The author subsystem may associate the received custom content with a report specification to construct a draft report. Custom content generation and draft report construction are further described above in relation to FIGS. 1-3.

At 406, a user interface subsystem (e.g., UI subsystem 306, 360) may display the draft report on a client device (e.g., device 106, 114, 200), as further described above in relation to FIGS. 1-3.

At 408, the author subsystem may receive one or more user edits to the draft article, as further described above in relation to FIGS. 1-3.

At 410, the author subsystem may store the one or more user edits in association with the draft article, as further described above in relation to FIGS. 1-3.

At 412, the author subsystem may receive an indication to publish the edited draft article, as further described above in relation to FIGS. 1-3.

At 414, the author subsystem may publish the edited draft report on at least one channel, as further described above in relation to FIGS. 1-3.

With reference now to FIG. 4B, a method 420 of generating reports using deep learning models based on user input is detailed, according to one or more embodiments disclosed herein. Note that references to specific subsystems may be generally understood to be references to backend 120, depending on embodiment architecture. Note also that references to a user interface/UI subsystem may be generally understood to be references to an author subsystem, and vice versa, depending on embodiment architecture.

At 422, an author subsystem (e.g., backend 120, author 302, 364) of an author system of the embodiments described herein (e.g., system 100) may receive initial user input comprising a first report parameter or set of report parameters. In some embodiments, the initial user input may comprise a first entity identifier that identifies a first entity (e.g., organization, club, etc.) and a first topic identifier that identifies a first topic. Report parameters are further described above in relation to FIGS. 1-3.

At 424, a user interface subsystem (e.g., backend 120, UI subsystem 306, 360) of the author system of the embodiments described herein (e.g., system 100) may provide a first user input interface (e.g., screen 202a) on a first client device (e.g., device 106, 114, 200) comprising a first plurality of user input elements (e.g., elements 204a, 206a). In some embodiments, the identity (number, placement, construction, etc.) of the first plurality of user input elements may be determined based on a first input specification. In some embodiments, the first input specification may be associated with the first entity and the first topic within the system 100. Input specifications of the embodiments are further described above in relation to FIGS. 1-3.

At 426, the author subsystem may receive a first user input of the first user interface comprising material information of a first subject. As may appreciated, user input of a user interface generally means user input (information, data, images, video, etc., references to information, data, images, video, etc.) originating from a user interface.

At 428, the author subsystem may generate a first custom content prompt based on the a first report parameter or set of report parameters and the material information of the first subject. In some embodiments, the first parameter may comprise a first entity and topic. In some embodiments, the first custom content prompt may include (e.g., incorporate and/or reference) data included in a first entity dataset associated with the first entity (first entity dataset data). In some embodiments, the first entity dataset data may comprise user input information originating from one or more different users. In some embodiments, the user input information may comprise one or more images relating to the first subject. Prompts, custom content prompts, and entity datasets are further described above in relation to FIGS. 1-3.

At 430, the author subsystem may prompt a first deep learning model (e.g., model 304) using the first custom content prompt. Deep learning models of the embodiments herein are further described above in relation to FIGS. 1-3.

At 432, the author subsystem may receive output returned from the first deep learning model in response to the custom content prompting. In general, the output may comprise a first set of custom content. Receiving model output and custom content are further described above in relation to FIGS. 1-3.

At 434, the user interface subsystem may provide a first draft report interface (e.g., screen 202b) on the first client device comprising a first plurality of content editing elements (e.g., elements 204b, 206b). In some embodiments, the identity (number, placement, construction, etc.) and layout (e.g., location on screen, publishing layout, etc.) of the first plurality of content editing elements may be determined based on a first report specification. In some embodiments, the first report specification may be associated with the first entity and the first topic within the system 100. Report specifications of the embodiments are further described above in relation to FIGS. 1-3.

At 436, the user interface subsystem may display the first custom content on the first draft report interface. In general, the user interface subsystem (e.g., backend 120, UI subsystem 306, 360) may populate a draft report interface with custom content in any suitable manner sufficient to provide the functionality of the embodiments described herein. Displaying custom content in a draft report (e.g., draft report interface) is further described above in relation to FIGS. 1-3.

At 438, the author subsystem may receive a first edit input of the first draft report interface. In general, edit input of a draft report interface generally means edit-related information and/or data (or references to information or data) originating from the draft report interface. The first edit input may modify (e.g., alter, delete, add, etc.) a portion of the first custom content. Draft report interfaces and editing content are further described above in relation to FIGS. 1-3.

At 440, the author subsystem may receive a publish indicator of the first draft report interface. A publish indicator of a draft report interface generally comprises any suitable mechanism for a publication instruction, message, status flag, etc. to be communicated by the draft report interface to system 100 (e.g., backend 120). Publication of draft reports is further described above in relation to FIGS. 1-3.

At 442, the author subsystem may publish the modified custom content as a first report on one or more channels. Publication of draft reports is further described above in relation to FIGS. 1-3. Note that, in some of the embodiments herein, publication of draft reports may include storing the modified draft report (i.e., the final version or publication) in system 100 for later publication in any suitable channel, including paper, e-book, email, web based content channels, social media channels, etc.

### Privacy Enhancement Using Confounding Elements

With reference now to FIG. 5, shown is a schematic illustrating certain aspects of one or more system and method embodiments disclosed herein that are useful for protecting individual identities from being inferred by deep learning models.

As indicated above, system 100 embodiments herein may comprise one or more subsystems/components (e.g., author subsystem 302, 364, prompt component 368) configured to interact with one or more deep learning models (e.g., model 304) to generate custom content and reports based on user input. In some embodiments, user input may include individualized data. As used herein, Individualized data may be understood to comprise any data that is generated by an individual, that concerns an individual, and/or that is identifying data of an individual. Unless context dictates otherwise, the individual may be understood to mean an individual person. Identifying data and personal data are terms that may be used interchangeably herein and may be understood to refer to any data that is tightly associated to a person in a manner such that traditional methods may uniquely identify the person based on the personal data (e.g., a person's name and age; a person's last k residences and age; a person's birthdate, birthplace, gender, and employment; a person's age, gender and residence, etc.). As used herein, identifying data that is material to identifying an individual (material personal data) means an individual's name, age, date of birth, and social security number. As may be appreciated, some non-limiting examples of user input in the systems and methods disclosed herein that may contain individualized data may include, but are not limited to, club roster information, club event information (images or video of an event showing one or more human participants, text content describing an event having personally identifying information, names), etc. In some embodiments, such user input information may be anonymized; in others, it may not be anonymized.

In general, some embodiments of author system 100 disclosed herein may provide for interacting with deep learning models using identifying and/or personal data of a person in a manner that tends to degrade the model's ability to infer identity of the person, such as by reducing the accuracy of the identify inferences of the model in relation to the person once at least one training iteration of the model has been effected based on a dataset that includes at least one confounding element, as further described below.

In general, identifying trait information may comprise generally any category of information that tends to be useful in traditional systems and methods for identifying a person. In some embodiments, a set of identifying trait information may comprise personal activity trait information, biometric trait information, character trait information, lifestyle trait information, etc. In some embodiments, personal activity trait information may comprise generally any activity-related information of a person; in some non-limiting examples: personal group activity related trait information (e.g., sports team affiliation, social group (e.g., social media) affiliation and activities, personal team or club statistics or activities, etc.). In some embodiments, biometric trait information may comprise generally any biological or behavioral information that uniquely characterizes a person when combined with one or more other biometric traits; in some non-limiting examples: face, fingerprints, height, weight, hand geometry, voice, signature, keystroke dynamics, gait, etc. information In some embodiments, character trait information may comprise generally any personal character-related information; in some non-limiting examples: personality characterizing information, achievement information, etc. In some embodiments, lifestyle trait information may comprise generally any personal lifestyle-related information; in some non-limiting examples: family member information, pet information, residential information, career information, education information, etc.

In general, a confounding element may comprise generally any data element(s) that, when used by a model to train for at least one iteration, reduces the accuracy of (degrades) the model identification inferences of an individual (e.g., a person). In some embodiments, a confounding element may comprise at least one trait type and at least one confounding value that is not accurate relative to ground truth for an individual (e.g., person). In a non-limiting example, a confounding element may comprise, e.g., a first biometric trait of a person (e.g., height, age, etc.) and a confounding value that is not accurate relative to ground truth for a person. For example, if a real person (e.g., Marilyn Monroe) has a ground truth (actual) height of 5′5″, a confounding element in relation to that real person (Marilyn Monroe) may comprise a height trait type with a confounding value of, for example, 5′8″. Unless context dictates otherwise herein, a confounding element as used in the embodiments herein does not include material personal data.

With reference to FIG. 5, subsystem 500 of an exemplary system (e.g., system 100) of the embodiments described herein is shown. Confounding element 502 may comprise a trait type 504 and confounding value 506. Subsystem 500 may comprise at least one deep learning model input 508 (e.g., a prompt generated by backend 120) that may be utilized by system 100 to interact with at least one deep learning model (e.g., model 304, 512). In some embodiments, input 508 may comprise a chat-style API prompt and model 512 may comprise a model as described above in the relation to FIGS. 1-3. In one or more embodiments, subsystem 500 may be configured to provide at least one confounding element (e.g., element 502) to be injected and/or incorporated into model input 508 (e.g., custom content prompt) resulting in a confounding prompt 510. As used herein, a model prompt having at least one confounding element incorporated may be referenced as a confounding prompt (e.g., input 510).

Value 506 may comprise a confounding value (e.g., 5′8″) that is not accurate with respect to a ground truth value (e.g., 5′5″). When incorporated into a model prompt (e.g., prompt 508) via a confounding element (e.g., element 502), resulting in a confounding prompt (e.g., prompt 510), the confounding prompt may thereafter be provided to a model (e.g., by prompting the model using confounding prompt 510) such that any resulting inferences from that model (e.g., model 512) after at least one training iteration of the model based on information in the confounding element (e.g., trait 504 and value 506, a height of 5′8″) has a degraded inference ability concerning identification of the relevant person (e.g., Marilyn Monroe).

In some embodiments, an entity dataset may be anonymized by obscuring any material personal data in the dataset, resulting in an anonymized entity dataset. In some embodiments, an entity dataset may be anonymized by obscuring any individual names by replacing each with the same or substantially same name (e.g., “Jane Smith 1”, “Jane Smith 2”, etc.). Such datasets may be referred to as a materially anonymized entity dataset.

With reference now to FIG. 6, a method 600 of generating reports and articles using deep learning models based on user input and having privacy enhancements is detailed, according to one or more embodiments disclosed herein.

At 602, an author subsystem (e.g., backend 120, author 302, 364) of an author system of the embodiments described herein (e.g., system 100) may receive user input comprising individualized data of a person.

At 604, the author subsystem may generate a confounding prompt comprising at least one confounding element relating to the person. In some embodiments, the confounding prompt may be a custom content prompt, as described above in relation to FIGS. 1-3, having at least one confounding element incorporated or referenced in it. In some embodiments, author subsystem may generate an anonymized or materially anonymized dataset and incorporate and/or reference the anonymized or materially anonymized dataset in the custom content prompt and/or confounding prompt.

At 606, the confounding prompt may be executed on at least one deep learning model, generating custom content based on the confounding prompt.

At 608, the custom content may be displayed on a draft report interface of the system.

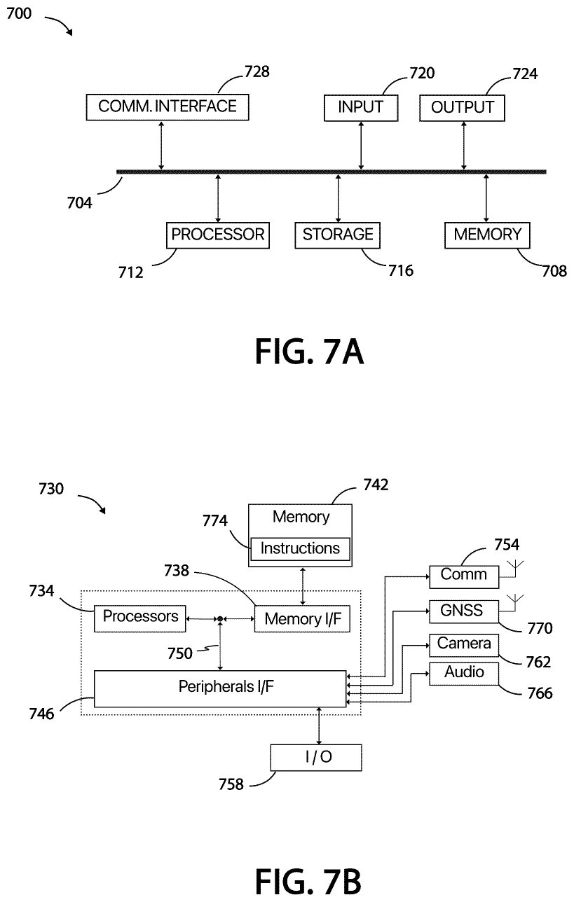

As described above, embodiments of the systems and methods described herein may be performed, in whole or in part, on or by one or more devices (computing devices), alone or in combination with one or more other devices and/or systems. Generally, computing devices (such as, e.g., devices 106, 108, 112, 114, 200) may be any suitable machines sufficient to run one or more aspects of the system described herein and provide the functionality described herein. FIG. 7A is a block diagram showing a high-level logical arrangement of certain components for an exemplary computing device 700 which may be employed to practice embodiments or portions of embodiments of the present disclosure. Bus 704 ties system components including memory 708 (e.g., ROM and/or RAM) to processor 712. Bus 704 may generally be any suitable type of bus structure using any suitable bus architecture, such as for example, a memory bus or controller, a peripheral bus, or a local bus. In some embodiments, bus 704 may include specialized architectures such as shared memory for integrated GPU(s) or on-chip interconnects. Information transfer to/from the bus (and components) may be accomplished by any suitable means, such as for example a BIOS stored in ROM 708 or the like. Memory 708 may also include specialized memories such as local caches and registers. Device 700 may have more than one processor 712 or may comprise a group or cluster of computing devices 700 networked together to provide greater processing capacity. Processor 712 may include any general purpose processor, as well as any special-purpose processor. Device 700 may include storage 716 (e.g., flash memory, hard disk drive, magnetic or optical disk drive, or the like). Storage 716 may include software, data and/or instructions for performing functions such as controlling processor 712. In general, the non-transitory computer readable storage media (memory or storage) provide nonvolatile storage of computer readable instructions, data structures, program modules and data for processing device 700. A person of ordinary skill in the art would know how to make variations to the basic components described to suit a particular function or need. Non-transitory computer-readable storage media expressly exclude media such as energy, carrier signals, electromagnetic waves, and signals per se.

With continuing reference to FIG. 7A, computing device 700 may comprise input devices 720 and output devices 724. In general, input devices 720 may be any number of input means, such as a digital camera or camera sub-system (e.g., e.g., CCD or CMOS-based camera sub-system), microphone for speech, a touch-sensitive screen for gesture or graphical input, a keyboard, mouse, and the like. Also in general, output devices 724 may include any number of output means, such as for example a visual monitor (touchscreen, LCD, CRT, etc.), a printer, and the like. Communications interface(s) 728 generally governs and manages the user input and system output. A person of ordinary skill in the art would know how to make variations to the basic components described to suit a particular function or need, and that the basic features described here may be substituted with improved software, hardware or firmware arrangements as they are developed.

The exemplary device of FIG. 7A is illustrated as including individual functional blocks. In general, the functions represented by these blocks may be provided through the use of either shared or dedicated hardware, including but not limited to, hardware capable of executing software and hardware that is purpose-built to operate as an equivalent to software executing on a general purpose processor. Some embodiments may include CPU, GPU, VPU, AI chip, FPGA, microprocessor and/or digital signal processor (DSP) hardware, read-only memory (ROM) for storing software performing the operations described herein, and random access memory (RAM) for storing results. Logical operations of various embodiments described herein may be implemented as, for example, a sequence of computer implemented steps, operations, or procedures running on a processor or processing resource within one or more general or specific-use computers. Device 700 may practice all or part of the recited methods, may be a part of the recited systems, and/or may operate according to instructions in the recited non-transitory computer-readable storage media. Such logical operations may be implemented as modules or components configured to control processor 712 to perform particular functions according to the programming of the module/component.

FIG. 7B is a block diagram showing a more granular logical arrangement of certain components demonstrating an architecture for an exemplary computing device 730 which may be employed to practice some embodiments or portions of some embodiments of the present disclosure. FIG. 7B and computing device 730 may be considered to be a more granular description of a subset of computing device 700 shown in FIG. 7A (e.g., mobile devices), and the descriptions relating to both should be construed congruently.

Generally, device 730 may be any computing device sufficient to implement the features, functions and processes described herein in relation to FIGS. 1-6, including handheld computers, mobile phones (e.g., iPhone®), laptop computers, tablet devices (e.g., iPad®), media players, personal digital assistants (PDA), wearable computers (e.g., Apple Watch®), or the like.

Computing device 730 may comprise one or more processors 734, a memory subsystem (e.g., interface/controller 738 and memory 742), and a peripheral subsystem (e.g., interface 746 and interfaced peripherals). The various components may be operatively associated in any suitable manner; for example, on one integrated circuit board (ICB) or multiple ICBs, via one or more hard or soft interfaces, etc. One or more buses or signal lines (e.g., bus 750) may couple the various components. A person of ordinary skill will appreciate that the architecture shown in FIG. 7B is but one exemplary architecture for computing device 730, and that computing device 730 may have more or fewer components than shown, or a different configuration of components. Components may be implemented in hardware, software, firmware, or a combination of hardware, software and firmware.

Communication subsystem 754 may comprise one or more wireless communication subsystems implementing one or more wireless communication protocols (e.g., networking protocols). Generally, wireless communication subsystem 754 may comprise one or more radio and/or infrared transmitters and receivers (or transceivers). Additionally or alternatively, communication subsystem 754 may comprise one or more ports (e.g., USB) for connectivity to one or more computing devices, which may themselves be wired or wireless communication devices.

Generally any communication protocol and the components needed to implement the protocol via communication subsystem 754 sufficient to perform the functions described herein may be utilized in the embodiments of this disclosure. Some exemplary and non-limiting implementations include those that are configured to operate over cellular (e.g., GSM, GPRS, CDMA, EDGE) networks, IEEE802.xx communication networks (e.g., Wi-Fi, Wi-Max, ZigBee®), and/or Bluetooth® networks. In some embodiments, communication subsystem 754 may be configured to permit computing device 730 to synchronize with a host device using one or more protocols, such as, for example, TCP/IP, HTTP, UDP, ICMP, FTP, SOAP, and any other similar, suitable protocol or technology.

Referring still to FIG. 7B, computing device 730 may include peripherals such as input/output subsystem 758 (that may itself include inputs/outputs such as a touchscreen subsystem, keyboard, mouse, etc. (not shown)), sensor subsystem 762, camera subsystem 766, and audio subsystem 770.

In one or more embodiments, computing device 730 may also comprise Global Navigation Satellite System (GNSS) subsystem 774. GNSS subsystem 774 comprises a GNSS receiver configured to receive GNSS (e.g., GPS) satellite signals and determine and output/make available the current geolocation information (e.g., location coordinates & time) of the receiver/device on a predetermined schedule.

Peripherals interface 746 may comprise a monolithic interface or multiple, specialized interfaces that themselves may comprise one or more components (hardware, software, firmware, or combinations thereof) that provide interfacing of peripheral subsystems with processors 734. In some embodiments, sensor subsystem 762 may include sensors such as motion sensor 778 and compass 782. In some embodiments, motion sensor 778 and compass 782 may be used to determine movement and orientation of the device 730.

In general, memory 742 may be any suitable non-transitory machine-readable medium that can store instructions and data for use by processors 734. For example, memory 742 may comprise a high-speed random access and/or non-volatile memory including instructions configured to cause a computing device such as device 730 to perform operations and/or store data. In addition, memory 742 may comprise machine-readable storage including instructions configured to cause a computing device such as device 730 to perform operations and/or to store data. Memory 742 may comprise a memory hierarchy, including cache, main memory and secondary memory. The memory hierarchy may be implemented using any combination of RAM, ROM, FLASH, magnetic and/or optical storage devices, and the like.

In general, memory 742 may store any instructions 786 for implementing the features and processes of the embodiments disclosed herein, as described in reference to FIGS. 1-6. Some non-limiting examples may include operating system instructions (e.g., iOS, Android, etc.), instructions that facilitate communicating with other devices, computers or servers, camera instructions that facilitate camera-related processes and functions, GUI instructions that facilitate GUI-related processes and functions, GNSS/navigation instructions to facilitate GNSS and navigation-related processes and functions, model instructions to implement one or more models and/or training one or more models, sensor instructions that facilitate sensor-related processes and functions, and media instructions to facilitate media-related processes and functions.

Processors 734 may be implemented in generally any suitable manner capable of executing the instructions to perform the operations and functions described in relation to the embodiments herein. Non-limiting examples may include one or more CPUs, GPUs, VPUs, AI chips, microprocessors, multicore processors, coprocessors, CPLDs, ASIPs, microcontrollers, ICs, ASICs, FPGAS, PLAS, and/or accelerators. A person or ordinary skill will understand that processors 734 may be configured for a particular use or configured to execute instructions stored in volatile or non-volatile memory or otherwise accessible to processors 734 in order to perform the steps or operations according to embodiments of the present disclosure.

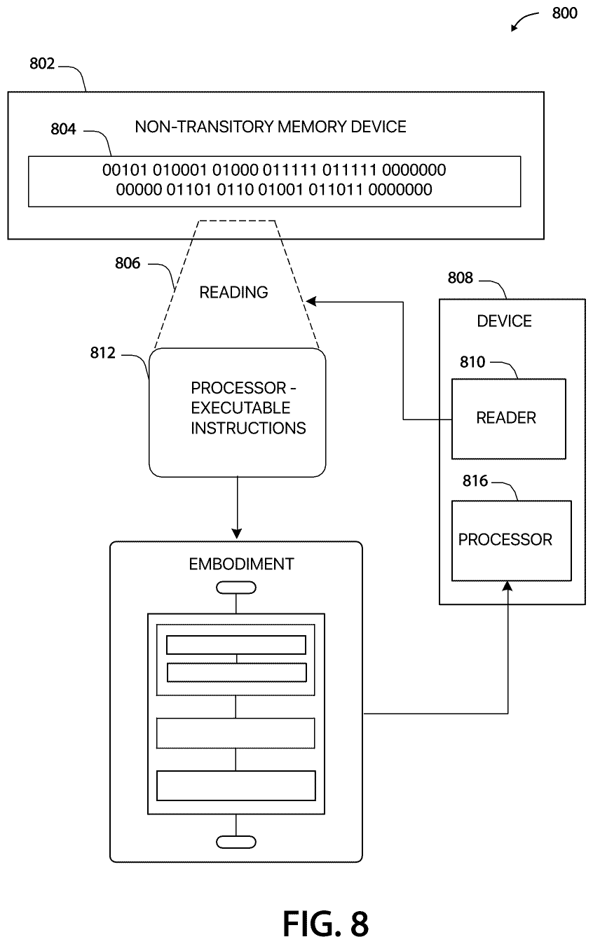

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein. The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example methods 400, 420 of FIG. 4 and 600 of FIG. 6, for example. In some embodiments, the processor-executable instructions 812 are configured to cause implementation of a system, such as at least some of the example system embodiments of FIGS. 1-3,5, for example.

As used in this application, “component,” “module,” “system”, “subsystem”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example”, “e.g.”, and/or the like is used herein to mean serving as an example, instance, illustration, etc., and not necessarily as advantageous, and not intending to imply a closed set. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

We claim:

1. An author system comprising:
at least one processor; and
memory storing instructions that, when executed by the at least one processor, cause the system to perform a set of operations, the set of operations comprising:
receiving, by an author subsystem of the author system, an initial user input comprising a first entity identifier that identifies a first entity and a first topic identifier that identifies a first topic;
providing, by a user interface subsystem of the author system, a first user interface on a first client device comprising a first plurality of user input elements, wherein the identity of the first plurality of user input elements is determined based on a first input specification, wherein the first input specification is associated with the first entity and the first topic within the system;
receiving, by the author subsystem, a first user input of the first user interface comprising material information of a first subject;
generating, by the author subsystem, a first custom content prompt based on the first entity, the first topic, and the material information of the first subject;
prompting, by the author subsystem, a first deep learning model using the first custom content prompt;
receiving, by the author subsystem, output returned from the first deep learning model in response to the prompting using the first custom prompt, wherein the output comprises a first set of custom content;
providing, by the user interface subsystem, a first draft report interface on the first client device comprising a first plurality of content editing elements, wherein the identity and layout of the first plurality of content editing elements is determined based on a first report specification, wherein the first report specification is associated with the first entity and the first topic within the system; and
displaying, by the user interface subsystem, the first custom content on the first draft report interface.

2. The system of claim 1, further comprising:
receiving, by the author subsystem, a plurality of edit inputs of the first draft report interface, wherein the plurality of edit inputs modifies a portion of the first custom content;
receiving, by the author subsystem, a publish indicator of the first draft report interface; and
publishing on one or more channels, by the author subsystem, a first final report comprising the first custom content as modified by the plurality of edit inputs.

3. The system of claim 1, wherein the first custom content prompt includes first entity dataset data.

4. The system of claim 2, wherein the first custom content prompt includes first entity dataset data.

5. The system of claim 3, wherein the first entity dataset data comprises entity author persona information of the first entity.

6. The system of claim 3, wherein the first entity dataset data comprises materially anonymized first entity dataset data and wherein the first custom content prompt includes materially anonymized first entity dataset data and one or more confounding elements.

7. The system of claim 3, wherein the first custom content prompt is a chat-style API prompt having a system role instruction comprising a first entity author persona of the first entity that was previously generated by the first deep learning model.

8. The system of claim 3, wherein the first entity dataset data comprises a first set of user input information and wherein the user input information in the first set of user input information originates from a plurality of users.

9. The system of claim 8, wherein the first set of user input information comprises a plurality of images relating to the first subject.

10. A method comprising:
receiving, by an author subsystem of the author system, an initial user input comprising a first entity identifier that identifies a first entity and a first topic identifier that identifies a first topic;
providing, by a user interface subsystem of the author system, a first user interface on a first client device comprising a first plurality of user input elements, wherein the identity of the first plurality of user input elements is determined based on a first input specification, wherein the first input specification is associated with the first entity and the first topic within the system;
receiving, by the author subsystem, a first user input of the first user interface comprising material information of a first subject;
generating, by the author subsystem, a first custom content prompt based on the first entity, the first topic, and the material information of the first subject;
prompting, by the author subsystem, a first deep learning model using the first custom content prompt;
receiving, by the author subsystem, output returned from the first deep learning model in response to the prompting using the first custom prompt, wherein the output comprises a first set of custom content;
providing, by the user interface subsystem, a first draft report interface on the first client device comprising a first plurality of content editing elements, wherein the identity and layout of the first plurality of content editing elements is determined based on a first report specification, wherein the first report specification is associated with the first entity and the first topic within the system; and
displaying, by the user interface subsystem, the first custom content on the first draft report interface.

11. The method of claim 10, further comprising:
receiving, by the author subsystem, a plurality of edit inputs of the first draft report interface, wherein the plurality of edit inputs modifies a portion of the first custom content;
receiving, by the author subsystem, a publish indicator of the first draft report interface; and
publishing on one or more channels, by the author subsystem, a first final report comprising the first custom content as modified by the plurality of edit inputs.

12. The method of claim 10, wherein the first custom content prompt includes first entity dataset data.

13. The method of claim 11, wherein the first custom content prompt includes first entity dataset data.

14. The method of claim 12, wherein the first entity dataset data comprises entity author persona information of the first entity.

15. The method of claim 12, wherein the first entity dataset data comprises materially anonymized first entity dataset data and wherein the first custom content prompt includes materially anonymized first entity dataset data and one or more confounding elements.

16. The method of claim 12, wherein the first custom content prompt is a chat-style API prompt having a system role instruction comprising a first entity author persona of the first entity that was previously generated by the first deep learning model.

17. The method of claim 12, wherein the first entity dataset data comprises a first set of user input information and wherein the user input information in the first set of user input information originates from a plurality of users.

18. The method of claim 17, wherein the first set of user input information comprises a plurality of images relating to the first subject.

19. An author system comprising:
at least one processor; and
memory storing instructions that, when executed by the at least one processor, cause the system to perform a set of operations, the set of operations comprising:
receiving, by an author subsystem of the author system, a first user input comprising material information relating to a first report subject;
generating, by the author subsystem, a first draft report based on the material information, wherein the first draft report comprises custom content output of a first deep learning model;
displaying, by a user interface subsystem of the author system, the first draft report on a first user device;
receiving, by the author subsystem, a plurality of user edits to the first draft report;
storing, by the author subsystem, the plurality of user edits in association with the first draft report;
receiving, by the author subsystem, an indication to publish a first final report, wherein the first final report comprises the first draft report as modified by the plurality of user edits; and
publishing, by the author subsystem, the first final report on at least one channel.

20. The system of claim 19, wherein generating a first draft report based on the material information comprises constructing, by the author subsystem, a first custom content prompt and prompting the first deep learning model with the first custom content prompt, wherein the first custom content prompt comprises a chat-style API prompt having a first system role instruction comprising author persona information of a first entity and a first user role instruction incorporating the material information and information relating to the first entity.
